(19) United States
(12) Patent Application Publication
(10) Pub. No.: US 2026/0277345 A1
(43) Pub. Date: Sep. 17, 2026

(54) ELECTRONIC PEN

(71) Applicant: Shenzhen Xinwei Intelligent Technology Co., LTD, Guangdong (CN)

(72) Inventors: Wenjian LIU, Guangdong (CN); Yongping JIANG, Guangdong (CN); Shu CHEN, Guangdong (CN)

(73) Assignee: Shenzhen Xinwei Intelligent Technology Co., LTD, Guangdong (CN)

(21) Appl. No.: 19/674,092

(22) Filed: May 11, 2026

Related U.S. Application Data
(63) Continuation of application No. PCT/CN2025/119268, filed on Sep. 5, 2025.

(30) Foreign Application Priority Data
Nov. 27, 2024 (CN) 202411722932.7

(51) Int. Cl. G06F 3/0354

(52) U.S. Cl. CPC G06F 3/03545

(57) ABSTRACT

The present application relates to the technical field of terminals, and discloses an electronic pen, including: a pen barrel, provided with a first accommodating cavity; where one end of the pen barrel is provided with an opening, and the opening is communicated with the first accommodating cavity; a pen tip, located at a side of the opening; a first electrode, inserted into the first accommodating cavity; where the pen tip is detachably connected to the first electrode through the opening; and a second electrode, fixedly connected with the pen barrel; where at least part of the second electrode is inserted into the first accommodating cavity; the second electrode is sleeved outside the first electrode and is spaced apart from the first electrode.

### CROSS-REFERENCE TO RELATED APPLICATIONS

The present application is a continuation of International Application No. PCT/CN2025/119268, filed on September 5, 2025, which claims priority to Chinese patent application No. 202411722932.7, filed with China National Intellectual Property Administration on November 27, 2024, and entitled “Electronic Pen”. Both of the aforementioned applications are hereby incorporated by reference in their entireties.

### TECHNICAL FIELD

The present application relates to the technical field of terminals, and in particular to an electronic pen.

### BACKGROUND

An electronic pen is a device that combines pen-and-paper writing with digital technology. The electronic pen is usually used as a digital handwriting input tool, which records a user's handwritten content in real time and converts it into digital form for storing, or transmitting to a computer or another device. Generally, the electronic pen is internally provided with an electrode assembly for transmitting or receiving signals. Presently, the electrode assembly is usually integrated into a component by injection molding, electroplating, etc., but such electrode assembly typically requires multiple injection molding and electroplating processes. The multiple integration processes result in high manufacturing difficulty and low yield.

In view of this, the present application provides an electronic pen, to solve the problems of high manufacturing difficulty and low yield of the electrode assembly.

In a first aspect, the present application provides an electronic pen, including: a pen barrel, provided with a first accommodating cavity; where one end of the pen barrel is provided with an opening, and the opening is communicated with the first accommodating cavity; a pen tip, located at a side of the pen barrel where the opening is located; a first electrode, inserted into the first accommodating cavity; where the pen tip is detachably connected to the first electrode through the opening; and a second electrode, fixedly connected with the pen barrel; where at least part of the second electrode is inserted into the first accommodating cavity; the second electrode is sleeved outside the first electrode and is spaced apart from the first electrode.

In an implementation, the pen tip includes a conducting member and a pen tip housing, one end of the conducting member is connected to the pen tip housing, and the other end of the conducting member is detachably connected to the first electrode; a side of the pen tip housing facing the pen barrel is provided with an annular groove, and the annular groove extends circumferentially around the conducting member, and is spaced apart from the conducting member; the second electrode is sleeved outside the conducting member, and at least part of the second electrode is embedded in the annular groove and is spaced apart from the conducting member.

In an implementation, an annular boss is formed at the opening of the pen barrel; the second electrode includes a first tube body and a second tube body, and the first tube body is coaxially connected with the second tube body; at least part of the first tube body is located outside the first accommodating cavity, and the second tube body is located in the first accommodating cavity; the first tube body and the second tube body respectively abut against two sides of the annular boss to be fixed to the pen barrel.

In an implementation, the electronic pen further includes: a first support member, located in the first accommodating cavity; where the first support member is provided with a second accommodating cavity communicated with the first accommodating cavity, and at least part of the second tube body is located in the second accommodating cavity; an insulating ring, where the insulating ring is disposed in the second accommodating cavity, and is sleeved outside the second tube body to isolate the first support member and the second tube body.

In an implementation, the electronic pen further includes a third electrode, and the third electrode is disposed on the insulating ring and is spaced apart from the second tube body.

In an implementation, the electronic pen further includes: a first support member, located in the first accommodating cavity; where the first support member is provided with a second accommodating cavity communicated with the first accommodating cavity; a third tube body, located in the first accommodating cavity, and fixedly connected with an end of the first support member away from the pen tip; where the third tube body is provided with a third accommodating cavity communicated with the second accommodating cavity; a second support member, located in the third accommodating cavity and connected to the third tube body; where at least part of the first electrode is located in the third accommodating cavity and is connected to the second support member.

In an implementation, the second support member is provided with a mounting groove, and at least part of the first electrode is located in the mounting groove; the electronic pen further includes: a main board member, located on a side of the first electrode away from a bottom wall of the mounting groove; the main board member is electrically connected with the first electrode and the second electrode; a plurality of connecting members, passing through the second support member, the first electrode and the main board member to fixedly connect the second support member, the first electrode and the main board member; the connecting members are connected to a grounding end of the main board member.

In an implementation, the electronic pen further includes: a first insulating member, disposed in the mounting groove and located between the first electrode and the second support member; a second insulating member, located between the first electrode and the main board member.

In an implementation, the second support member, the first insulating member, the first electrode, the second insulating member and the main board member together form a plurality of connecting holes, and the plurality of connecting members are respectively inserted into the plurality of connecting holes; each of the connecting holes includes a first connecting hole and a second connecting hole, the first connecting hole is formed in the second support member, and the second connecting hole is formed in the first electrode; where the second support member is provided with a first annular projection extending around the first connecting hole, and the first annular projection extends towards the second connecting hole; the connecting member is disposed in the first annular projection; the first insulating member is provided with a second annular projection, and the second annular projection extends towards the second connecting hole, and surrounds on an outer side of the first annular projection.

In an implementation, the electronic pen further includes a sensing member; the sensing member is located in the third accommodating cavity, and is connected to the third tube body and the second support member respectively; the sensing member is connected with the first electrode via the second support member to sense a force transmitted by the first electrode; and the sensing member is electrically connected with the main board member.

In an implementation, the sensing member and the third tube body are integrally formed.

In an implementation, the sensing member includes: a deformation portion, where the deformation portion includes an overlapping segment and a deformation segment that are connected to each other, and the overlapping segment intersects with the deformation segment; the overlapping segment is fixedly connected with the second support member, and an end of the deformation segment away from the overlapping segment is connected with the third tube body; the first electrode transmits the force to the deformation segment via the second support member and the overlapping segment, to cause the deformation segment to be deformed; a sensing portion, connected to the deformation segment and configured to sense force information received by the deformation segment.

With the technical solution of the present application, the second electrode is fixed to the pen barrel, and the first electrode is disposed in the first accommodating cavity of the pen barrel, and is connected to the pen tip as an integral structure through the opening. By the configuration of the electronic pen, the first electrode and the second electrode are designed as independent structures, and are connected to form an integrate structure through the pen tip and the pen barrel, and thus there is no need for multiple integration processes. The electrode assembly can be formed through simple assembly, which facilitates machining and manufacturing, and reduces production cost. In addition, the assembly method is simple and reliable, thereby improving the yield.

### BRIEF DESCRIPTION OF DRAWINGS

In order to illustrate the technical solutions in embodiments of the present application or in the prior art more clearly, the accompanying drawings needed for describing the embodiments or the prior art will be introduced hereinafter briefly. Apparently, the accompanying drawings in the following description are merely some embodiments of the present application, and those skilled in the art may still derive other drawings according to these accompanying drawings without creative effort.

FIG. 1 is a sectional view of a local structure of an electronic pen in an embodiment of the present application.

FIG. 2 is a partially enlarged schematic view of portion A in FIG. 1.

FIG. 3 is a structural schematic view of a second electrode in an embodiment of the present application.

FIG. 4 is a structural schematic view of a first electrode in an embodiment of the present application.

FIG. 5 is a schematic view of a local structure of an electronic pen in an embodiment of the present application.

FIG. 6 is a structural schematic view of a first support member in an embodiment of the present application.

FIG. 7 is a structural schematic view of an insulating ring in an embodiment of the present application.

FIG. 8 is a schematic view of the assembly of a first support member and a third tube body in an embodiment of the present application.

FIG. 9 is a structural schematic view of a second support member and a bracket in an embodiment of the present application.

FIG. 10 is a structural schematic view of a first insulating member in an embodiment of the present application.

### Illustration of reference signs

1. Pen barrel; 1a. First accommodating cavity; 1b. Opening; 1c. First tapered segment; 1d. Annular boss;

2. Pen tip; 21. Conducting member; 211. Ball head portion; 212. Rod portion; 22. Pen tip housing; 221. Annular groove;

3. First support member; 30. Second accommodating cavity; 31. Second tapered segment; 32. Main body segment; 33. Connecting segment; 331. Retaining groove; 34. Recessed platform;

4. First electrode; 41. First connecting portion; 411. Recessed hole; 42. Fixing portion; 421. Second connecting hole;

5. Second electrode; 51. First tube body; 511. Straight portion; 512. Tapered portion; 52. Second tube body; 521. Large-diameter portion; 522. Small-diameter portion;

6. Insulating ring; 61. First annular body portion; 62. Flange portion;

7. Third tube body; 70. Third accommodating cavity; 71. Retaining block; 72. Bracket; 721. Second annular body portion; 722. Second connecting portion;

8. Second support member; 811. Mounting groove; 812. First connecting hole; 813. First annular protrusion; 814. Third connecting part;

9. Main board member;

10. Connecting member;

11. First insulating member; 110. Third connecting hole; 111. Second annular protrusion;

12. Second insulating member;

13. Sensing member; 131. Deformation portion; 1311. Overlapping segment; 1312. Deformation segment; 132. Sensing portion;

X. First direction; Y. Second direction.

### DESCRIPTION OF EMBODIMENTS

In order to make the purpose, technical solutions and advantages of embodiments of the present application clearer, the technical solutions in the embodiments of the present application will be clearly and completely described hereinafter with reference to the accompanying drawings in the embodiment of the present application. Obviously, the embodiments described are only a part of, not all of, the embodiments of the present application. Based on the embodiments in the present application, all other embodiments obtained by those skilled in the art without creative labor shall fall within the protection scope of the present application.

Electronic pens are widely used in tablet computers, office computers, mobile phones and other fields, the existing electronic pens generally include an electrode assembly for transmitting and receiving signals. Generally, the electrode assembly include a transmitting electrode, a receiving electrode and other structures, where the transmitting electrode transmits signals, and the receiving electrode receives signals. In terms of the structure of the transmitting electrode, a pen tip of the electronic pen is internally provided with a metal member as a transmitting end of the transmitting electrode, where the metal member is connected to the transmitting electrode, and the transmitting electrode is connected to a main board through an FPC (Flexible Printed Circuit) or other forms. When in service, the main board transmits an electrical signal to the metal member within the pen tip, where the metal member is generally a metal ball head. The metal ball head forms an electric field, and changes of the electric field are read by a host terminal (tablet and other devices), to produce writing and drawing reactions. In terms of structure, the receiving electrode is also electrically connected to the main board through an FPC via an elastic metal conductive structure (such as a spring). When in service, the receiving electrode receives change signals of the electric field from the host terminal, and transmits them to the main board, so that the electronic pen performs a corresponding response. The receiving electrode can also be used as a transmitting electrode, so that the host terminal detects the tilt of the pen to reflect functions such as different writing thicknesses of the pen.

Presently, the electrode assembly in related technologies is generally integrated into a component through injection molding, electroplating, etc., and then electrically connects an electrode circuit to the main board through an elastic sheet, or an FPC, or other structures. During the injection molding process of the electrode assembly, different processing materials need to be injected into a mold, resulting in relatively high difficulty of the injection molding process. This is prone to operational errors, thereby causing the electrode assembly to become defective, and leading to a low yield.

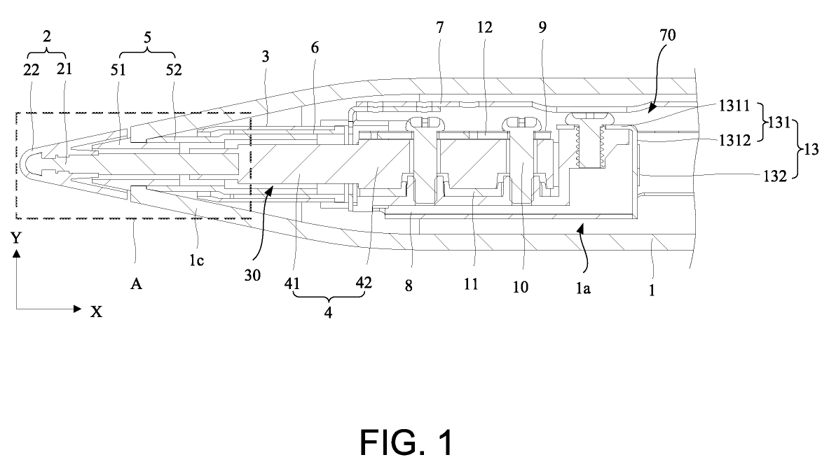

In view of this, embodiments of the present application provide an electronic pen, for overcoming at least one of the above technical problems. With reference to FIG. 1 to FIG. 10, the embodiments of the present application will be described hereinafter.

According to the embodiments of the present application, an electronic pen is provided. As shown in FIG. 1, the electronic pen includes a pen barrel 1, a pen tip 2 provided at one end of the pen barrel 1, and a first electrode 4 and a second electrode 5 disposed in the pen barrel 1.

Specifically, the pen barrel 1 is provided with a first accommodating cavity 1a, and the first accommodating cavity 1a extends along a first direction X. And an end of the pen barrel 1 along the first direction X is provided with an opening 1b, and the opening 1b is in communication with the first accommodating cavity 1a. The pen tip 2 is located at the end of the pen barrel 1 along the first direction X, specifically on a side of the pen barrel 1 where the opening 1b is located. The first direction X specifically refers to a length direction of the pen barrel 1. The first electrode 4 is inserted into the first accommodating cavity 1a, and is specifically inserted into the first accommodating cavity 1a along the first direction X. The pen tip 2 is detachably connected to the first electrode 4 through the opening 1b. The second electrode 5 is fixedly connected with the pen barrel 1, and at least part of the second electrode 5 is inserted into the first accommodating cavity 1a. The second electrode 5 is sleeved outside the first electrode 4, and is spaced apart from the first electrode 4.

In this embodiment, the second electrode 5 is fixed to the pen barrel 1, and the first electrode 4 is disposed in the first accommodating cavity 1a of the pen barrel 1, and is connected with the pen tip 2 through the opening 1b to form an integral structure. By the configuration of the electronic pen, the first electrode 4 and the second electrode 5 are designed as independent structures, and are connected to form an integrate structure through the pen tip 2 and the pen barrel 1, and thus there is no need for multiple integration processes. The electrode assembly can be formed through simple assembly, which facilitates machining and manufacturing, and reduces the production cost. In addition, the assembly method is simple and reliable, thereby improving the yield.

It can be understood that in this embodiment, the first electrode 4 can be a transmitting electrode, and the connection between the pen tip 2 and the first electrode 4 can ensure the sensitive response of the first electrode 4 to the pressure applied by the pen tip 2. The second electrode 5 can be a receiving electrode, and the second electrode 5 is fixed to the pen barrel 1, so the second electrode 5 will not tilt or move due to the movement of the pen tip 2, improving the reliability of the electronic pen.

For the sake of convenience in description, an extension direction of the pen barrel 1 is defined as the first direction X, and a direction perpendicular to the first direction X is defined as the second direction Y. In some cases, the first direction X is a central axis direction of the pen barrel 1, and the second direction Y is a radial direction of the pen barrel 1.

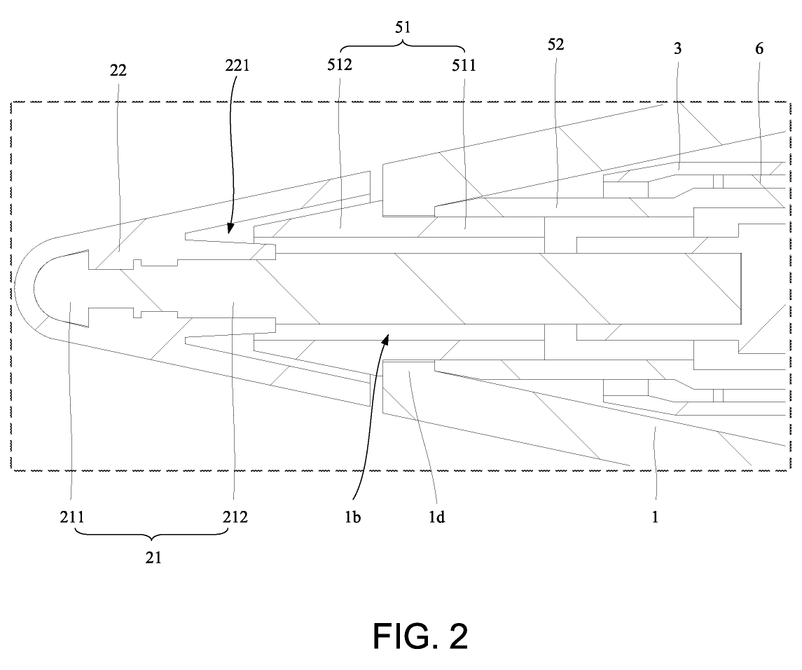

In some embodiments, as shown in FIG. 2, an annular boss 1d is formed at the opening 1b of the pen barrel 1. The second electrode 5 includes a first tube body 51 and a second tube body 52, and the first tube body 51 is coaxially connected with the second tube body 52. At least part of the first tube body 51 is located outside the first accommodating cavity 1a, and the second tube body 52 is located in the first accommodating cavity 1a. The first tube body 51 and the second tube body 52 respectively abut against two sides of the annular boss 1d, so that the second electrode 5 is fixed to the pen barrel 1. By this way, the structure of the second electrode 5 is simple, which facilitates the assembly of the electronic pen. Exemplarily, the first tube body 51 can be in detachable connection with the second tube body 52, which facilitates the disassembly and assembly of the second electrode 5, such as threaded connection, snap-fitted connection, etc. Certainly, in some embodiments not shown, the first tube body 51 can be in fixable connection with the second tube body 52, such as by press fitting, etc. for fixing; or the first tube body 51 and the second tube body 52 are formed integrally.

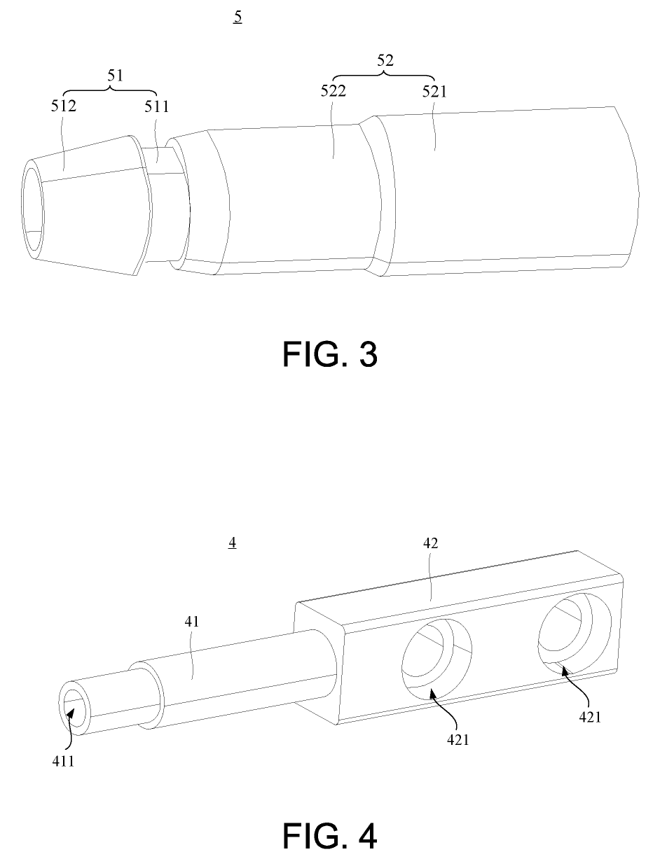

In some embodiments, as shown in FIGS. 2 and 3, the first tube body 51 includes a straight portion 511 and a tapered portion 512, the straight portion 511 is inserted into the first accommodating cavity 1a through the opening 1b, and the tapered portion 512 is located outside the first accommodating cavity 1a. The second tube body 52 is located in the first accommodating cavity 1a and is detachably connected to the straight portion 511.

Specifically, in some embodiments, along the first direction X, a cross-sectional shape of the straight portion 511 is configured to be the same as a shape of the opening 1b of the pen barrel 1. And along the second direction Y, a size of the straight portion 511 is provided to match a size of the opening 1b, to ensure the stability of the structure and avoid the shaking of the parts. Exemplarily, the opening 1b of the pen barrel 1 is circular, the straight portion 511 is cylindrical, and an outer diameter size of the straight portion 511 is the same as an inner diameter size of the opening 1b.

Furthermore, a radial size of the tapered portion 512 gradually decreases in a direction away from the straight portion 511. A junction between the straight portion 511 and the tapered portion 512 forms an annular abutment surface, and the annular abutment surface abuts against an outer surface of the annular boss 1d. An end surface of the second tube body 52 near an end of the first tube body 51 abuts against an inner surface of the annular boss 1d.

Furthermore, in some embodiments, along the second direction Y, a size of the second tube body 52 is provided to be greater than the size of the straight portion 511, and the second tube body 52 is coaxially sleeved outside the straight portion 511. Exemplarily, the second tube body 52 may be connected to the straight portion 511 via a threaded connection, a snap-fitted connection, etc. Exemplarily, the second tube body 52 includes a large-diameter portion 521 and a small-diameter portion 522, which are connected smoothly, the small-diameter portion 522 is sleeved outside the straight portion 511, and the small-diameter portion 522 abuts against the inner surface of the annular boss 1d described above. The large-diameter portion 521 is located on a side of the small-diameter portion 522 away from the annular boss 1d.

It can be understood that the first tube body 51 and the second tube body 52 are coaxially disposed, and are formed with a through hole along an axial direction; and the first electrode 4 is inserted into the through hole. For the second tube body 52, the arrangement of the large-diameter portion and the small-diameter portion increases a radial size of the through hole, facilitating arranging the first electrode 4, and ensuring that the first electrode 4 can be spaced apart from the second electrode 5.

Exemplarily, a side of the pen barrel 1 near the opening 1b is provided with a first tapered segment 1c, and correspondingly, an end of the small-diameter portion 522 near the annular boss 1d can also be tapered to match a shape of an inner wall of the first tapered segment 1c, improving the stability of the structure.

Furthermore, in some embodiments, as shown in FIG. 2, the pen tip 2 includes a conducting member 21 and a pen tip housing 22, and one end of the conducting member 21 is connected with the pen tip housing 22, and the other end thereof is detachably connected with the first electrode 4. Specifically, the conducting member 21 is a metal member, and the pen tip housing 22 is an insulating member. A side of the pen tip housing 22 towards the pen barrel 1 is provided with an annular groove 221, and the annular groove 221 extends circumferentially around the conducting member 21 and is disposed apart from the conducting member 21. The second electrode 5 is sleeved outside the conducting member 21. That is, the first tube body 51 and the second tube body 52 are sleeved outside the conducting member 21. At least part of the second electrode 5 is embedded in the annular groove 221. Specifically, at least part of the first tube body 51 is embedded in the annular groove 221, to be spaced apart from the conducting member 21. In this embodiment, at least part of the second electrode 5 is embedded in the annular groove 221, thus the annular groove 221 serves to radially limit the second electrode 5, so that the second electrode 5 is apart from the conducting member 21 and the first electrode 4 connected to the conducting member 21.

Exemplarily, the first tube body 51 includes the straight portion 511 and the tapered portion 512 described above, the straight portion 511 is connected with the second tube body 52, the tapered portion 512 is located between the pen tip housing 22 and the pen barrel 1, and at least part of the tapered portion 512 is embedded in the annular groove 221. Correspondingly, the annular groove 221 is a tapered groove, and a radial size of the annular groove 221 gradually decreases along a direction away from the second electrode 5.

Exemplarily, the conducting member 21 can be connected to the first electrode 4 via a threaded connection, a snap-fitted connection, etc.

Exemplarily, the conducting member 21 can be a solid metal member, and the conducting member 21 includes a ball head portion 211 and a rod portion 212 that are connected together. At least part of the ball head portion 211 and the rod portion 212 is embedded in the pen tip housing 22, and the rod portion 212 is inserted into the first accommodating cavity 1a, and is detachably connected with the first electrode 4. The pen tip housing 22 can be a plastic member, and the pen tip housing 22 can be obtained by injection molding process. The pen tip housing 22 can be injection-molded on an outside of the ball head portion 211 and the rod portion 212. In order to ensure the connection strength between the conducting member 21 and the pen tip housing 22, a concave-and-convex structure can be provided at the connection between the conducting member 21 and the pen tip housing 22.

In some embodiments, the electronic pen further includes a support structure, which is inserted into the first accommodating cavity 1a and is fixedly connected with the pen barrel 1. The first electrode 4 described above is connected to the support structure, to be fixed in the first accommodating cavity 1a.

The support structure includes a first support member 3, and the first support member 3 is located in the first accommodating cavity 1a. And the first support member 3 is provided with a second accommodating cavity 30 communicated with the first accommodating cavity 1a. At least part of the first electrode 4 is inserted into the second accommodating cavity 30, and at least part of the second electrode 5 is inserted into the second accommodating cavity 30. Specifically, at least part of the second tube body 52 of the second electrode 5 is located within the second accommodating cavity 30.

Furthermore, the electronic pen further includes an insulating ring 6, which is disposed in the second accommodating cavity 30 and is sleeved outside the second tube body 52 to isolate the first support member 3 and the second tube body 52. The arrangement of the insulating ring 6 between the first support member 3 and the second tube body 52 can ensure that the second electrode 5 always keeps a distance from the first support member 3, ensuring the safety of the overall structure.

In some embodiments, the first support member 3 is roughly cylindrical. The first support member 3, the insulating ring 6, the first electrode 4, and the second electrode 5 are coaxially arranged, to ensure the structural safety and reliability. In an implementation, the first support member 3, the insulating ring 6, the first electrode 4, and the second electrode 5 are coaxially arranged with the pen tip 2 and the pen barrel 1, with the axis directions of respective components being the first direction X, and the radial directions thereof being the second direction Y.

In some embodiments, the insulating ring 6 is connected with the first support member 3 to ensure the stability of the relative position. The insulating ring 6 can be connected fixedly or detachably with the first support member 3.

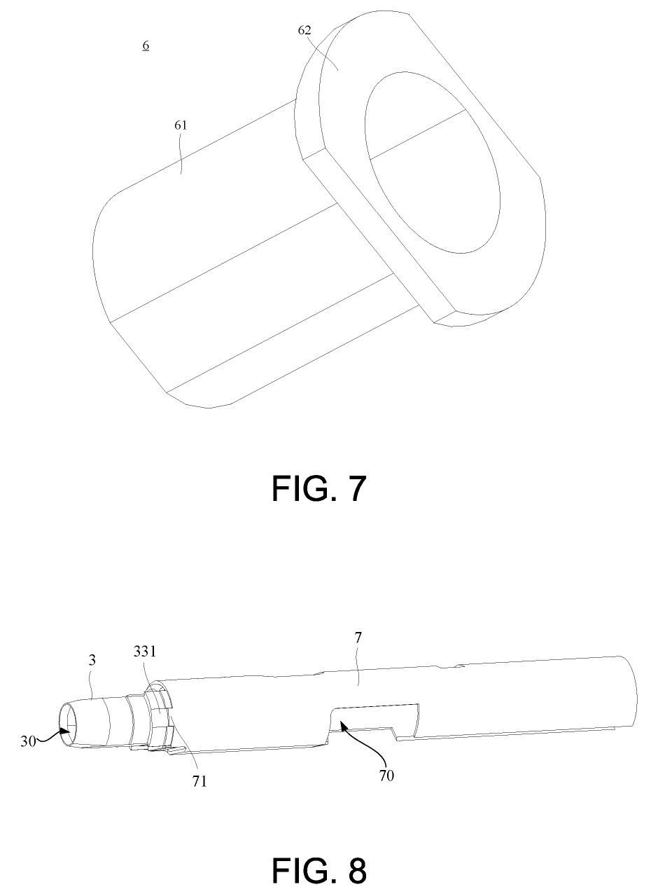

In an implementation, the insulating ring 6 is detachably connected with the first support member 3. Exemplarily, as shown in FIG. 7, the insulating ring 6 includes a first annular body portion 61 and a flange portion 62 disposed at an axial end of the first annular body portion 61. An end of the first support member 3 away from the second electrode 5 is formed with a recessed platform 34, the first annular body portion 61 is inserted into the second accommodating cavity 30 of the first support member 3, and the flange portion 62 abuts against this recessed platform 34.

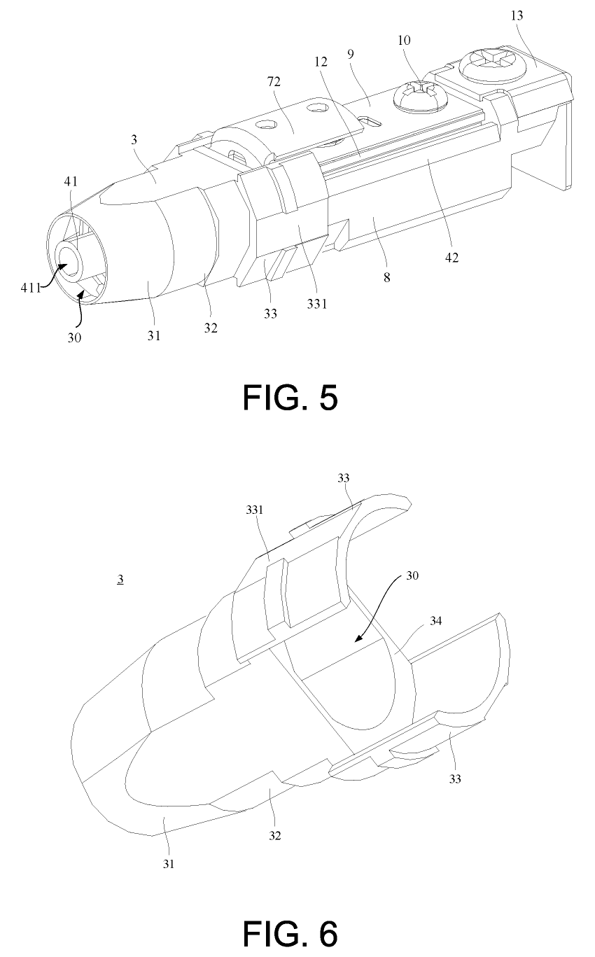

Exemplarily, as shown in FIGS. 5 and 6, the first support member 3 includes a second tapered segment 31, a main body segment 32, and a connecting segment 33, which are connected in sequence in an axial direction. The second tapered segment 31 has a shape of a tapered cylinder, which matches the inner wall of the first tapered segment 1c of the pen barrel 1, to facilitate installation. The main body segment 32 has a cylindrical structure, and the second tapered segment 31 and the main body segment 32 together form the second accommodating cavity 30 described above. The connecting segment 33 is disposed on a peripheral side of the main body segment 32 and extends towards a direction away from the second tapered segment 31; and the connecting segment 33 and the main body segment 32 together form the recessed platform 34 described above.

In some embodiments, the electronic pen further includes a third electrode, which is disposed on the insulating ring 6 and is spaced apart from the second tube body 52. The third electrode can have a role of enhancing the signal function of the first electrode 4 or the second electrode 5, to further improve the functions and performance of the electronic pen. A position of the third electrode on the insulating ring 6 is not specifically defined in the present application, as long as the third electrode is spaced apart from the second electrode 5 and plays a role in signal enhancement. Exemplarily, the third electrode can be integrated into the insulating ring by the means electroplating, etc.

Furthermore, the support structure described above further includes a third tube body 7 and the second support member 8. The third tube body 7 is located in the first accommodating cavity 1a, and is fixed with an end of the first support member 3 away from the pen tip 2. The third tube body 7 is provided with a third accommodating cavity 70 communicated with the second accommodating cavity 30. The second support member 8 is located in the third accommodating cavity 70 and is connected to the third tube body 7. At least part of the first electrode 4 is located in the third accommodating cavity 70 and is connected with the second support member 8, and at least part of the first electrode 4 extends into the second accommodating cavity 30. The third tube body 7 is connected with the pen barrel 1, such as via a snap-fitted connection, welding, bolt connection, etc. It can be understood that the first support member 3 and the third tube body 7 are disposed in sequence along the first direction X, and the first support member 3 is located at an end of the pen barrel 1 near the pen tip 2.

The fixed connection method between the third tube body 7 and the first support member 3 is not specifically defined in the present application, and the third tube body 7 and the first support member 3 can be connected via a snap-fitted connection, bonding by dispensing, or welding. Exemplarily, the first support member 3 includes the connecting segment 33 described above, and a periphery side of the connecting segment 33 is provided with at least one retaining groove 331. Correspondingly, the third tube body 7 and the first support member 3 are coaxially arranged, and a side of the third tube body 7 near the first support member 3 is provided with at least one retaining block 71, and the retaining block 71 is snap-fitted into the retaining groove 331. The arrangement of the retaining groove 331 and the retaining block 71 can prevent the relative rotation or radial movement between the third tube body 7 and the first support member 3, ensuring stable relative positions of various structures within the third tube body 7 and the first support member 3, thus improving the safety and reliability of the overall structure.

In some embodiments, the second support member 8 is provided with a mounting groove 811, and at least part of the first electrode 4 is located in the mounting groove 811. Specifically, the first electrode 4 includes a first connecting portion 41 and a fixing portion 42 that are connected in sequence along the first direction X, where the first connecting portion 41 is detachably connected with the pen tip 2, and specifically detachably connected with the conducting member 21 of the pen tip 2. Exemplarily, a side of the first connecting portion 41 towards the conducting member 21 is provided with a recessed hole 411, and the conducting member 21 can be bolted into the recessed hole 411 or snap-fitted into the recessed hole 411. The fixing portion 42 is located in the mounting groove 811 described above and is fixedly connected with the second support member 8.

The second support member 8 can be directly connected to the third tube body 7, or connected via a bracket 72.

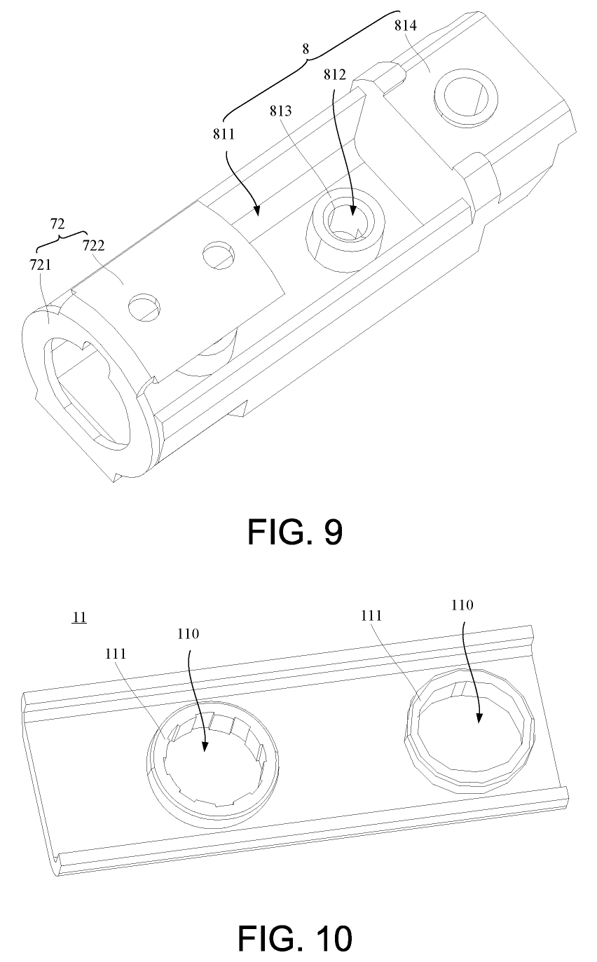

Exemplarily, as shown in FIG. 9, the third tube body 7 further includes the bracket 72, the bracket 72 is located in the third accommodating cavity 70 and is connected between the third tube body 7 and the second support member 8. Specifically, the bracket 72 is located at a side of the third tube body 7 and the second support member 8 near the first support member 3. The bracket 72 includes the second annular body portion 721 and the second connecting portion 722 that are connected to each other, where the second annular body portion 721 is located between the second support member 8 and the first support member 3. The fixing portion 42 of the first electrode 4 is fixed in the mounting groove 811 of the second support member 8, and the first connecting portion 41 is inserted into the first support member 3 (that is, the second accommodating cavity 30) through a center hole of the second annular body portion 721. The second connecting portion 722 is connected to a side of the second annular body portion 721 in the radial direction and extends along the first direction X, and the second connecting portion 722 is connected to an inner wall of the third tube body 7. Exemplarily, the second connecting portion 722 can be in the shape of an arc-shaped plate, and be adapted to a curved surface of the inner wall of the third tube body 7. Exemplarily, the second connecting portion 722 can be connected with the third tube body 7 by welding, or via a bolt connection, etc.

In some embodiments, the electronic pen further includes a main board member 9 and a plurality of connecting members 10. The main board member 9 is located a side of the first electrode 4 away from a bottom wall of the mounting groove 811, that is, above the mounting groove 811. The main board member 9 is electrically connected with the first electrode 4 and the second electrode 5. The plurality of connecting members 10 described above all pass through the second support member 8, the first electrode 4 and the main board member 9 along the second direction Y to fix the second support member 8, the first electrode 4 and the main board member 9. The connecting members 10 are electrically connected to a ground end of the main board member 9. In this embodiment, the connecting members 10 not only realize a fixed connection among the main board member 9, the first electrode 4 and the second support member 8, and improve the structural integrity and stability of the electronic pen, but also play a grounding role. It can be understood that in some embodiments, the electronic pen includes the third electrode, which is also electrically connected to the main board member 9.

The connection method between the first electrode 4, the second electrode 5, and the third electrode and the main board member 9 is not specifically defined in the present application, as long as it can play the function of electrical connection. Taking the electrical connection between the second electrode 5 and the main board member 9 as an example, a metal elastic member can be used, and the metal elastic member is compressed and abuts between the main board member 9 and the second electrode 5, so as to realize the electrical connection between the second electrode 5 and the main board member 9.

Furthermore, in some embodiments, the electronic pen further includes a first insulating member 11 and a second insulating member 12, the first insulating member 11 is disposed in the mounting groove 811 and is located between the first electrode 4 and the second support member 8, and the first electrode 4 is insulated from the second support member 8 by the first insulating member 11. The second insulating member 12 is located between the first electrode 4 and the main board member 9, the first electrode 4 is insulated from the main board member 9 via the second insulating member 12, and the second insulating member 12 also has the role of supporting the main board member 9 and structural reinforcement.

In some embodiments, along the second direction Y, the main board member 9, the second insulating member 12, the first electrode 4, the first insulating member 11 and the second support member 8 are stacked in sequence. The second support member 8, the first insulating member 11, the first electrode 4, the second insulating member 12 and the main board member 9 are together formed with a plurality of connecting holes, and the plurality of connecting members 10 respectively pass through the plurality of connecting holes.

As shown in FIG. 4, FIG. 9 and FIG. 10, the connecting hole includes a first connecting hole 812, a second connecting hole 421 and a third connecting hole 110, where the first connecting hole 812 is formed in the second support member 8, specifically formed in the bottom wall of the mounting groove 811; the second connecting hole 421 is formed in the first electrode 4, and the third connecting hole 110 is formed in the first insulating member 11.

Exemplarily, the second support member 8 is provided with a first annular projection 813 extending around the first connecting hole 812, and the first annular projection 813 extends towards the second connecting hole 421. The connecting member 10 is connected to the first annular projection 813 to achieve grounding. Exemplarily, the connecting members 10 can be connected to the first annular projection 813 by a threaded connection, a snap-fitted connection, etc. The first insulating member 11 is provided with a second annular projection 111 extending around the third connecting hole 110, and the second annular projection 111 extends towards the second connecting hole 421, and surrounds on an outer side of the first annular projection 813. The second annular projection 111 is interposed between an inner wall of the second connecting hole 421 and the first annular projection 813, to avoid contact between the second support member 8 and the first electrode 4.

Exemplarily, at least parts of the first annular projection 813 and the second annular projection 111 are embedded in the second connecting hole 421, the second annular projection 111 is interposed between the second connecting hole 421 and the first annular projection 813, and the second annular projection 111 abuts against the inner wall of the second connecting hole 421 to play a positioning role for the first electrode 4.

Furthermore, in some embodiments, the electronic pen further includes a sensing member 13, which is located in the third accommodating cavity 70, and is connected to the third tube body 7 and the second support member 8, respectively. The sensing member 13 is connected with the first electrode 4 via the second support member 8 to sense the force transmitted by the first electrode 4. And the sensing member 13 is electrically connected to the main board. When writing using the electronic pen, the pen tip 2 is connected with the first electrode 4, the first electrode 4 is connected with the sensing member 13 via the second support member 8, the pen tip 2 transmits the received force to the sensing member 13 through the first electrode 4. The force information transmitted by the first electrode 4 is sensed by the sensing member 13, and then the sensed information is transmitted to the main board member 9 connected to the sensing member 13, and the information is processed by the main board member 9. Specifically, a side of the second support member 8 away from the first support member 3 is provided with a third connecting member 814, and the sensing member 13 is mounted on the second support member 8 via the third connecting member 814, with a simple structure and low production difficulty.

Exemplarily, the sensing member 13 includes a deformation portion 131 and a sensing portion 132, and the deformation portion 131 includes an overlapping segment 1311 and a deformation segment 1312 that are connected to each other. The overlapping segment 1311 extends along the first direction X, and is fixedly connected with the second support member 8, specifically connected to the third connecting portion 814 of the second support member 8 by means of bolts, snap fits, etc., so that the first electrode 4 transmits the force to the overlapping segment 1311 via the second support member 8. The deformation segment 1312 intersects with the overlapping segment 1311. In an implementation, the deformation segment 1312 extends along the second direction Y, and an end of the deformation segment 1312 away from the overlapping segment 1311 is connected to the third tube body 7. The first electrode 4 transmits the force to the deformation segment 1312 via the second support member 8 and the overlapping segment 1311 to cause the deformation segment 1312 to be deformed. It is equivalent that one side of the deformation segment 1312 is connected to the overlapping segment 1311, and the other side thereof is connected to the third tube body 7, thus when the overlapping segment 1311 receives the force from the second support member 8, the force will be transmitted to the deformation segment 1312, causing the deformation segment 1312 to be deformed. Meanwhile, the sensing portion 132 is connected to the deformation segment 1312. The sensing portion 132 can be a strain sheet, which is generally attached to the deformation segment 1312. The sensing portion 132 will be deformed with the deformation of the deformation segment 1312, the sensing portion 132 is usually made of a sensitive material, such as thin film or metal foil. When subjected to external force, the sensing portion 132 will undergo corresponding deformation, resulting in changes in its resistance, capacitance, or inductance. The sensing portion 132 is configured to sense the force information received by the deformation segment 1312, and then converts it into an electrical signal and transmits the electrical signal to the main board member 9 for processing.

More specifically, the sensing member 13 can be connected with the third tube body 7 by welding, bonding or abutting, etc.; or the sensing member 13 can be integrated with the third tube body 7. In an implementation, the sensing member 13 and the third tube body 7 are formed integrally, which has high connection reliability, simplifies the production process of the electronic pen, and improves production efficiency. More specifically, the deformation portion 131 of the sensing member 13 described above is integrated with the third tube body 7, and the sensing portion 132 is connected to the deformation segment 1312 of the deformation portion 131.

Although the embodiments of the present application are described with reference to the accompanying drawings, various amendments and changes may be made by those skilled in the art without departing from the spirit and scope of the present application, and such amendments and changes fall within the scope of the appended claims.

What is claimed is:

1. An electronic pen, comprising:
a pen barrel, provided with a first accommodating cavity, wherein one end of the pen barrel is provided with an opening, and the opening is communicated with the first accommodating cavity;
a pen tip, located at a side of the pen barrel where the opening is located;
a first electrode, inserted into the first accommodating cavity; wherein the pen tip is detachably connected to the first electrode through the opening; and
a second electrode, fixedly connected with the pen barrel; wherein at least part of the second electrode is inserted into the first accommodating cavity; the second electrode is sleeved outside the first electrode and is spaced apart from the first electrode.

2. The electronic pen according to claim 1, wherein the pen tip comprises a conducting member and a pen tip housing, one end of the conducting member is connected to the pen tip housing, and the other end of the conducting member is detachably connected to the first electrode; a side of the pen tip housing facing the pen barrel is provided with an annular groove, and the annular groove extends circumferentially around the conducting member, and is spaced apart from the conducting member;
the second electrode is sleeved outside the conducting member, and at least part of the second electrode is embedded in the annular groove and is spaced apart from the conducting member.

3. The electronic pen according to claim 1, wherein an annular boss is formed at the opening of the pen barrel;
the second electrode comprises a first tube body and a second tube body, and the first tube body is coaxially connected with the second tube body; at least part of the first tube body is located outside the first accommodating cavity, and the second tube body is located in the first accommodating cavity; the first tube body and the second tube body respectively abut against two sides of the annular boss to be fixed to the pen barrel.

4. The electronic pen according to claim 3, wherein the electronic pen further comprises:
a first support member, located in the first accommodating cavity; wherein the first support member is provided with a second accommodating cavity communicated with the first accommodating cavity, and at least part of the second tube body is located in the second accommodating cavity;
an insulating ring, wherein the insulating ring is disposed in the second accommodating cavity, and is sleeved outside the second tube body to isolate the first support member and the second tube body.

5. The electronic pen according to claim 4, wherein the electronic pen further comprises a third electrode, and the third electrode is disposed on the insulating ring and is spaced apart from the second tube body.

6. The electronic pen according to claim 1, wherein the electronic pen further comprises:
a first support member, located in the first accommodating cavity; wherein the first support member is provided with a second accommodating cavity communicated with the first accommodating cavity;
a third tube body, located in the first accommodating cavity, and fixedly connected with an end of the first support member away from the pen tip; wherein the third tube body is provided with a third accommodating cavity communicated with the second accommodating cavity;
a second support member, located in the third accommodating cavity and connected to the third tube body; wherein at least part of the first electrode is located in the third accommodating cavity and is connected to the second support member.

7. The electronic pen according to claim 2, wherein the electronic pen further comprises:
a first support member, located in the first accommodating cavity; wherein the first support member is provided with a second accommodating cavity communicated with the first accommodating cavity;
a third tube body, located in the first accommodating cavity, and fixedly connected with an end of the first support member away from the pen tip; wherein the third tube body is provided with a third accommodating cavity communicated with the second accommodating cavity;
a second support member, located in the third accommodating cavity and connected to the third tube body; wherein at least part of the first electrode is located in the third accommodating cavity and is connected to the second support member.

8. The electronic pen according to claim 3, wherein the electronic pen further comprises:
a first support member, located in the first accommodating cavity; wherein the first support member is provided with a second accommodating cavity communicated with the first accommodating cavity;
a third tube body, located in the first accommodating cavity, and fixedly connected with an end of the first support member away from the pen tip; wherein the third tube body is provided with a third accommodating cavity communicated with the second accommodating cavity;
a second support member, located in the third accommodating cavity and connected to the third tube body; wherein at least part of the first electrode is located in the third accommodating cavity and is connected to the second support member.

9. The electronic pen according to claim 4, wherein the electronic pen further comprises:
a third tube body, located in the first accommodating cavity, and fixedly connected with an end of the first support member away from the pen tip; wherein the third tube body is provided with a third accommodating cavity communicated with the second accommodating cavity;
a second support member, located in the third accommodating cavity and connected to the third tube body; wherein at least part of the first electrode is located in the third accommodating cavity and is connected to the second support member.

10. The electronic pen according to claim 6, wherein the second support member is provided with a mounting groove, and at least part of the first electrode is located in the mounting groove;
the electronic pen further comprises:
a main board member, located on a side of the first electrode away from a bottom wall of the mounting groove; the main board member is electrically connected with the first electrode and the second electrode;
a plurality of connecting members, passing through the second support member, the first electrode and the main board member to fixedly connect the second support member, the first electrode and the main board member; the connecting members are connected to a grounding end of the main board member.

11. The electronic pen according to claim 7, wherein the second support member is provided with a mounting groove, and at least part of the first electrode is located in the mounting groove;
the electronic pen further comprises:
a main board member, located on a side of the first electrode away from a bottom wall of the mounting groove; the main board member is electrically connected with the first electrode and the second electrode;
a plurality of connecting members, passing through the second support member, the first electrode and the main board member to fixedly connect the second support member, the first electrode and the main board member; the connecting members are connected to a grounding end of the main board member.

12. The electronic pen according to claim 8, wherein the second support member is provided with a mounting groove, and at least part of the first electrode is located in the mounting groove;
the electronic pen further comprises:
a main board member, located on a side of the first electrode away from a bottom wall of the mounting groove; the main board member is electrically connected with the first electrode and the second electrode;
a plurality of connecting members, passing through the second support member, the first electrode and the main board member to fixedly connect the second support member, the first electrode and the main board member; the connecting members are connected to a grounding end of the main board member.

13. The electronic pen according to claim 9, wherein the second support member is provided with a mounting groove, and at least part of the first electrode is located in the mounting groove;
the electronic pen further comprises:
a main board member, located on a side of the first electrode away from a bottom wall of the mounting groove; the main board member is electrically connected with the first electrode and the second electrode;
a plurality of connecting members, passing through the second support member, the first electrode and the main board member to fixedly connect the second support member, the first electrode and the main board member; the connecting members are connected to a grounding end of the main board member.

14. The electronic pen according to claim 10, wherein the electronic pen further comprises:
a first insulating member, disposed in the mounting groove and located between the first electrode and the second support member;
a second insulating member, located between the first electrode and the main board member.

15. The electronic pen according to claim 11, wherein the electronic pen further comprises:
a first insulating member, disposed in the mounting groove and located between the first electrode and the second support member;
a second insulating member, located between the first electrode and the main board member.

16. The electronic pen according to claim 12, wherein the electronic pen further comprises:
a first insulating member, disposed in the mounting groove and located between the first electrode and the second support member;
a second insulating member, located between the first electrode and the main board member.

17. The electronic pen according to claim 14, wherein the second support member, the first insulating member, the first electrode, the second insulating member and the main board member together form a plurality of connecting holes, and the plurality of connecting members are respectively inserted into the plurality of connecting holes;
each of the connecting holes comprises a first connecting hole and a second connecting hole, the first connecting hole is formed in the second support member, and the second connecting hole is formed in the first electrode;
wherein the second support member is provided with a first annular projection extending around the first connecting hole, and the first annular projection extends towards the second connecting hole; the connecting member is disposed in the first annular projection; the first insulating member is provided with a second annular projection, and the second annular projection extends towards the second connecting hole, and surrounds on an outer side of the first annular projection.

18. The electronic pen according to claim 10, wherein the electronic pen further comprises a sensing member; the sensing member is located in the third accommodating cavity, and is connected to the third tube body and the second support member respectively; the sensing member is connected with the first electrode via the second support member to sense a force transmitted by the first electrode; and the sensing member is electrically connected with the main board member.

19. The electronic pen according to claim 18, wherein the sensing member and the third tube body are integrally formed.

20. The electronic pen according to claim 18, wherein the sensing member comprises:
a deformation portion, wherein the deformation portion comprises an overlapping segment and a deformation segment that are connected to each other, and the overlapping segment intersects with the deformation segment; the overlapping segment is fixedly connected with the second support member, and an end of the deformation segment away from the overlapping segment is connected with the third tube body; the first electrode transmits the force to the deformation segment via the second support member and the overlapping segment, to cause the deformation segment to be deformed;
a sensing portion, connected to the deformation segment and configured to sense force information received by the deformation segment.
